(19) United States
(12) Patent Application Publication
(10) Pub. No.: US 2005/0176866 A1
(43) Pub. Date: Aug. 11, 2005

(54) Use of metallocene waxes in powder paints

(76) Inventors: Ernst Krendlinger, Friedberg (DE); Hans-Dieter Nowicki, Gersthofen (DE)

Correspondence Address: CLARIANT CORPORATION;INTELLECTUAL PROPERTY DEPARTMENT, 4000 MONROE ROAD, CHARLOTTE, NC, 28205, US

(21) Appl. No.: 10/511,358

(22) PCT Filed: Apr. 4, 2003
(86) PCT No.: PCT/EP03/03518

(30) Foreign Application Priority Data
Apr. 12, 2002 (DE) 102 16 118.6

(51) Int. Cl. C08K 5/01

(52) U.S. Cl. 524/487

(57) ABSTRACT

The invention relates to the use of polyolefin waxes that have been synthesised by means of metallocene catalysts as additives in powder paints, in addition to a method for creating pigmented powder paints.

The present invention relates to the use of polyolefin waxes synthesized using metallocene catalysts as an additive in powdercoating materials and also to a process for producing pigmented powdercoating materials.

The preparation of powdercoating materials by extrusion in co-rotating twin-screw extruders or single-screw kneading apparatus is general knowledge. Powdercoating materials are composed of
binders, such as polyester resins, for example, which are crosslinked for example using epoxides, triglycidyl isocyanurate (TGIC), β-hydroxyalkylamine or blocked isocyanates (uretdiones)
pigments and fillers, unless the coating materials are clearcoats. The pigments must exhibit appropriately high thermal stability. Examples thereof are phthalocyanines, quinacridones, azo pigments, perylene and perinone pigments, benzimidazolone pigments, anthraquinone pigments, isoindolinone and isoindoline pigments, anthanthrone pigments, dioxazine pigments, quinophthalone pigments and diketopyrrolopyrrole pigments
additives, such as devolatilizers, flatting agents, antioxidants, tribological additives, leveling agents, and waxes for enhancing the scratch resistance.

In the preparation of powdercoating materials in accordance with the known state of the art the additives used include waxes, in order to achieve the following effects:
improving grindability
preventing deposits in spray equipment and the hose lines thereof
enhancing scratch resistance
enhancing abrasion resistance
improving dispersion harshness of the pigment component
orienting pigment particles in the case of effect pigments
improving the color strength
obtaining flatting effects
improving the tactility (“soft feel”)
improving lubricity
improving metal marking
improving the ease of incorporation of effect pigments
influencing Theological properties
improving blocking resistance
facilitating devolatilization in the course of extrusion
raising the throughput in the course of extrusion

In the preparation of the powdercoating material all of the constituents are first premixed in a mixer, then homogenized in an extruder or kneading apparatus at from 80 to 130° C. and finally brought to the ultimate particle size by grinding and classifying. In the preparation of pigmented systems it is particularly important to break down pigment agglomerates into very fine particles and to achieve maximum homogeneity in the dispersion of pigment aggregates, in order to give optimum color strength. At present this is done by introducing mechanical energy via the screw configuration of the extruders or kneading apparatus employed, without using a dispersing assistant.

The wax additives, which are used in a concentration of 0.01-10% by weight, based on the powdercoating material mass, are commonly polyolefin waxes, PTFE waxes, amide waxes, FT paraffins, montan waxes, natural waxes, macrocrystalline and microcrystalline paraffins, sorbitan esters and metallocene waxes.

Suitable polyolefin waxes are primarily polyethylene and polypropylene waxes. They can be prepared by thermal degradation of high-polymer polyolefins or by direct polymerization of corresponding monomers. Suitable polymerization techniques include high-pressure technologies, in which, for example, ethylene is reacted free-radically under high pressures and temperatures to form waxes, and also low-pressure or Ziegler techniques, where the olefin is polymerized using organometallic catalysts at comparatively low pressures and temperatures. The low-pressure technique permits not only the preparation of homopolymer waxes of uniform construction but also the synthesis of copolymers by joint polymerization of two or more olefins.

A variant of the low-pressure technique which has been disclosed more recently is a procedure in which metallocene compounds are used as organometallic catalysts. These metallocene compounds contain titanium, zirconium or hafnium atoms as active species and are generally employed in combination with cocatalysts, examples being organoaluminum compounds or boron compounds, preferably aluminoxane compounds. Polymerization takes place where necessary in the presence of hydrogen as a molar mass regulator. A feature of metallocene processes is that in comparison to the older Ziegler technology it is possible to obtain waxes having a narrower molar mass distribution, more uniform incorporation of comonomer, lower melting points and higher catalyst yields. Polymerization processes of this kind which operate with metallocene catalysts for the preparation of polyolefin waxes are described for example in EP-A-0 571 882.

EP-A-0 890 619 describes the use of metallocene polyolefin waxes in printing inks and paints. Not addressed therein are powdercoating materials, with their specific requirements concerning the addition of wax additives.

The invention was based on the object of improving the performance properties of powdercoating materials through use of a suitable dispersant.

It has now been found that polyolefin waxes prepared using metallocene catalysts are suitable with particular advantage for use as additives in powdercoating materials. Metallocene polyolefin waxes in particular display improved activity in respect of extrusion properties, flatting effect, lubricity, film hardness, abrasion resistance and dispersion harshness.

The invention accordingly provides for the use of polyolefin waxes synthesized using metallocene catalysts as an additive in powdercoating materials.

The polyolefin wax is preferably derived from olefins having 3 to 6 carbon atoms or from styrene.

Polyolefin waxes suitable in principle include homopolymers of ethylene and of propylene, copolymers of ethylene and propylene, or copolymers of ethylene or of propylene with one or more 1-olefins. 1-Olefins used are linear or branched olefins having 3-18 carbon atoms, preferably 3-6 carbon atoms. The 1-olefins may also carry an aromatic substitution.

Examples of suitable 1-olefins besides ethylene and propylene are 1-butene, 1-hexene, 1-octene or 1-octadecene, and also styrene. Particular preference is given to homopolymers of ethylene or propylene or to copolymers of ethylene with propylene or 1-butene. In the case of copolymers the ethylene content thereof is preferably 70-99.9%, in particular 80-99% by weight.

The polyolefin waxes used in accordance with the invention can be prepared either by direct polymerization with metallocene catalysts or by thermal degradation of polyolefin polymers, with the above composition, prepared using metallocene catalysts.

Used with particular preference are polyolefin waxes having a dropping point of between 70 and 165° C., in particular between 100 and 160° C., a melt viscosity at 140° C. (polyethylene waxes) or at 170° C. (polypropylene waxes) of between 10 and 10 000 mPas, in particular between 50 and 5000 mPas, and a density at 20° C. of between 0.85 and 0.98 g/cm³. Preferred polyolefin waxes have a molecular weight distribution M_{w}/Mₙ<5.

Metallocene catalysts for preparing polyolefin waxes or for preparing polyolefin polymers used for thermal degradation are chiral or nonchiral transition metal compounds of the formula M¹Lₓ. The transition metal compound M¹Lₓ contains at least one central metal atom M¹ attached to which there is at least one π ligand, e.g., a cyclopentadienyl ligand. Additionally it is possible for substituents, such as halogen, alkyl, alkoxy or aryl groups, to be attached to the central metal atom M¹. M¹ is preferably an element from main group III, IV, V or VI of the Periodic Table of the Elements, such as Ti, Zr or Hf. By cyclopentadienyl ligand are meant unsubstituted cyclopentadienyl radicals and substituted cyclopentadienyl radicals such as methylcyclopentadienyl, indenyl, 2-methylindenyl, 2-methyl-4-phenylindenyl, tetrahydroindenyl or octahydrofluorenyl radicals. The π ligands can be bridged or unbridged, and both single and multiple bridging—including bridging via ring systems—are possible. The term “metallocene” also embraces compounds containing more than one metallocene fragment, referred to as polynucleometallocenes. These may have any desired substitution pattern and bridging variants. The individual metallocene fragments of such polynucleometallocenes may be either identical or different from one another (EP-A-0 632 063).

General structure formulae of metallocenes and also their use for preparing polyolefin waxes are given for example in EP-A-0 571 882.

The polyolefin waxes used in accordance with the invention may be employed either as they are or in a polar-modified form. Polar modification can be achieved, for example, by oxidation with air or oxygen-containing gases or by graft attachment of, for example, unsaturated carboxylic acids such as, for instance, maleic acid. Examples of oxidative modification can be found in EP-A-0 890 583, examples of modification with unsaturated carboxylic acids in EP-A-0 941 257.

The polyolefin waxes of the invention can be used both in pure form and also in a blend with further wax components, not prepared using metallocene catalysts, in a fraction of 1-50% by weight. Blending may take place in the melt or by mixing the components in solid form. The following blend components are suitable:
a) polyethylene glycol
b) PE waxes,
c) PTFE waxes,
d) PP waxes,
e) amide waxes,
f) FT paraffins,
g) montan waxes,
h) natural waxes,
i) macrocrystalline and microcrystalline paraffins,
j) polar polyolefin waxes, or
k) sorbitan esters
l) polyamides,
m) polyolefins,
n) PTFE,
o) wetting agents,
p) silicates.

Additive a) comprises polyethylene glycol, molecular weight range preferably 10 to 50 000 daltons, in particular 20 to 35 000 daltons. The polyethylene glycol can be admixed in amounts of preferably up to 5% by weight to the composition comprising metallocene wax.

Additive b) comprises in preferred embodiments polyethylene homopolymer and copolymer waxes which have not been prepared by metallocene catalysis and which have a number-average molecular weight of from 700 to 10 000 g/mol with a dropping point of between 80 and 140° C.

Additive c) comprises in preferred embodiments polytetrafluoroethylene having a molecular weight of between 30 000 and 2 000 000 g/mol, in particular between 100 000 and 1 000 000 g/mol.

Additive d) comprises in preferred embodiments polypropylene homopolymer and copolymer waxes which have not been prepared by metallocene catalysis and which have a number-average molecular weight of from 700 to 10 000 g/mol with a dropping point of between 80 and 160° C.

Additive e) comprises in preferred embodiments amide waxes preparable by reacting ammonia or ethylenediamine with saturated and/or unsaturated fatty acids. The fatty acids comprise, for example, stearic acid, tallow fatty acid, palmitic acid or erucic acid.

Additive f) comprises in preferred embodiments FT paraffins having a number-average molecular weight of from 400 to 800 g/mol with a dropping point of from 80 to 125° C.

Additive g) preferably comprises montan waxes, including acid waxes and ester waxes, with a carboxylic acid carbon chain length of C₂₂ to C₃₆.

The ester waxes preferably comprise reaction products of the montanic acids with monohydric or polyhydric alcohols having 2 to 6 carbon atoms, such as ethanediol, butane-1,3-diol or propane-1,2,3-triol, for example.

Additive h) comprises in one preferred embodiment carnauba wax or candelilla wax.

Additive i) comprises paraffins and microcrystalline waxes which are obtained in the course of petroleum refining. The dropping points of such paraffins are preferably between 45 and 65° C., those of such microcrystalline waxes preferably between 73 and 100° C.

Additive j) comprises in preferred embodiments polar polyolefin waxes preparable by oxidizing ethylene or propylene homopolymer and copolymer waxes or by grafting them with maleic anhydride. Particular preference is given for this purpose to starting from polyolefin waxes having a dropping point of between 90 and 165° C., in particular between 100 and 160° C., a melt viscosity at 140° C. (polyethylene waxes) or at 170° C. (polypropylene waxes) of between 10 and 10 000 mPas, in particular between 50 and 5000 mPas, and a density at 20° C. of between 0.85 and 0.96 g/cm³.

Additive k) comprises in preferred embodiments reaction products of sorbitol with saturated and/or unsaturated fatty acids and/or montan acids. The fatty acids comprise for example stearic acid, tallow fatty acid, palmitic acid or erucic acid.

Additive l) comprises preferably ground polyamides, examples being nylon-6, nylon-6,6 or nylon-12. The particle size of the polyamides is preferably in the regrion of 5-200 μm, in particular 10-100 μm. Additive m) comprises polyolefins, in other words, for example, polypropylene, polyethylene or copolymers of propylene and ethylene of high or low density, with molar weights of preferably from 10 000 to 1 000 000 D, in particular from 15 000 to 500 000 D, as the numerical average of the molecular weight, whose particle size as a result of grinding is in the region of preferably 5-200 μm, in particular 10-100 μm.

Additive n) comprises thermoplastic PTFE having a molar weight of preferably 500 000-10 000 000 D, in particular 500 000-2 000 000 D, as numerical average, whose particle size as a result of grinding is in the region of preferably 5-200 μm, in particular 10-100 μm.

Additive o) comprises amphiphilic compounds which generally lower the surface tension of liquids. The wetting agents comprise, for example, alkyl ethoxylates, fatty alcohol ethoxylates, alkylbenzenesulfonates or betaines.

Additive p) comprises silicates which are not used as a filler or pigment in the formulas. Preference is given to using silicas or talc.

The mixing ratio of ingredient a) to ingredients b) to p) can be varied in the range from 1 to 50% by weight of a) to from 1 to 50% by weight of b) to p). If a mixture of two or more of ingredients b) to p) is used then the amount specified is valid for the sum of the amounts of those ingredients.

In one preferred embodiment the waxes are used in micronized form for the purpose according to the invention. Particular preference is given to using polyolefin wax and, if desired, admixed auxiliaries and additives in the form of an ultrafine powder having a particle size distribution d₉₀<40 μm.

The invention further provides a process for preparing powdercoating materials from binders, pigments and fillers and also customary auxiliaries, which comprises adding an additive as per the present invention.

### EXAMPLES

TABLE 1
Raw materials

| Product | Acid number | Dropping point | Viscosity |
|---|---|---|---|
| metallocene | 0 mg KOH/g | 124° C. | 250 mPas (140° C.) |
| PE wax 1) | | | |
| metallocene | 0 mg KOH/g | 135° C. | 40 mPas (170° C.) |
| PP wax 2) | | | |
| oxidized | 20 mg KOH/g | 114° C. | 200 mPas (120° C.) |
| metallocene | | | |
| PE wax 3) | | | |
| Ziegler PE wax | 0 mg KOH/g | 125° C. | 300 mPas (140° C.) |
| Ziegler PP wax | 0 mg KOH/g | 160° C.* | 1500 mPas (170° C.) |
| oxidized PE | 20 mg KOH/g | 114° C. | 200 mPas (120° C.) |
| wax | | | |
| amide wax | 6 mg KOH/g | 140° C. | 10 mPas (150° C.) |
| montan wax 1 | 17 mg KOH/g | 82° C. | 30 mPas (100° C.) |
| montan wax 2 | 14 mg KOH/g | 100° C. | 300 mPas (120° C.) |
| PTFE wax | — | — | — |
| carnauba wax | 9 mg KOH/g | 82° C. | 30 mPas (90° C.) |
| FT paraffin | 0 mg KOH/g | 110° C. | 15 mPas (120° C.) |

1) Preparation in accordance with EP-A-0 571 882
2) Preparation in accordance with EP-A-0 890 584
3) Preparation in accordance with EP-A-0 890 583
*Ring & ball softening point

TABLE 2
Specimens tested

| | | | | Mixing |
|---|---|---|---|---|
| Code | Wax 1 | Wax 2 | Wax 3 | ratio |
| M1 | oxidized | carnauba wax | | 1:1 |
| | metallocene | | | |
| | PE wax | | | |
| V1 | oxidized PE wax | carnauba wax | | 1:1 |
| M2 | metallocene PE wax | oxidized metallocene | | 7:3 |
| | | PE wax | | |
| V2 | PE wax | oxidized PE wax | | 7:3 |
| M3 | metallocene PE wax | amide wax | | 1:1 |
| V3 | PE wax | amide wax | | 1:1 |
| M4 | metallocene PE wax | PTFE wax | | 9:1 |
| V4 | PE wax | PTFE wax | | 9:1 |
| M5 | metallocene PE wax | oxidized metallocene | PTFE wax | 12:7:1 |
| | | PE wax | | |
| V5 | PE wax | oxidized PE wax | PTFE wax | 12:7:1 |
| M6 | metallocene PP wax | amide wax | | 1:1 |
| V6 | PP wax | amide wax | | 1:1 |
| M7 | metallocene PP wax | amide wax | | 5:1 |
| V7 | PP wax | amide wax | | 5:1 |
| M8 | metallocene PP wax | metallocene PE wax | | 1:1 |
| V8 | PP wax | PE wax | | 1:1 |
| M9 | metallocene PP wax | oxidized metallocene | | 1:1 |
| | | PE wax | | |
| V9 | PP wax | oxidized PE wax | | 1:1 |
| M10 | oxidized | montan wax 1 | montan | 2:1:1 |
| | metallocene | | wax 2 | |
| | PE wax | | | |
| V10 | oxidized PE wax | montan wax 1 | montan | 2:1:1 |
| | | | wax 2 | |
| M11 | metallocene PE wax | oxidized metallocene | sorbitan | 1:1:1 |
| | | PE wax | tristearate | |
| V11 | PE wax | oxidized PE wax | sorbitan | 1:1:1 |
| | | | tristearate | |
| M12 | metallocene PE wax | FT paraffin | | 5:1 |
| V12 | PE wax | FT paraffin | | 5:1 |

M = inventive example
V = comparative example
All specimens were micronized to a DV₅₀ of approximately 8 μm.

TABLE 3
Incorporation of micronized waxes into a blue hybrid
powdercoating material for the purpose of flatting
The waxes were mixed with the individual raw materials with one
another in a high-speed mixer and then the dry mixture was
extruded on a laboratory twin-screw extruder (PC19-25 from
APV) at 110° C. and 250 rpm, ground to <125 μm and applied
to aluminum or steel panels by means of a spraygun with corona
charging. After baking (15 minutes at 180° C.) the coated
panels were stored in a controlled-climate chamber for 24 hours,
after which the gloss (60°) was measured.

| | Wax | Wax fraction | Gloss (60° angle) |
|---|---|---|---|
| Example 1 | no wax | 0% | 96 |
| Example 2 | M2 | 0.5% | 90 |
| Example 3 | V2 | 0.5% | 92 |
| Example 4 | M2 | 1.0% | 88 |
| Example 5 | V2 | 1.0% | 90 |
| Example 6 | M2 | 2.0% | 80 |
| Example 7 | V2 | 2.0% | 83 |
| Example 8 | M3 | 0.5% | 93 |
| Example 9 | V3 | 0.5% | 96 |
| Example 10 | M3 | 1.0% | 90 |
| Example 11 | V3 | 1.0% | 94 |
| Example 12 | M3 | 2.0% | 88 |
| Example 13 | V3 | 2.0% | 91 |
| Example 14 | M4 | 0.5% | 30 |
| Example 15 | V4 | 0.5% | 35 |
| Example 16 | M4 | 1.0% | 7 |
| Example 17 | V4 | 1.0% | 10 |
| Example 18 | M4 | 2.0% | 7 |
| Example 19 | V4 | 2.0% | 8 |
| Example 20 | M6 | 0.5% | 90 |
| Example 21 | V6 | 0.5% | 94 |
| Example 22 | M6 | 1.0% | 85 |
| Example 23 | V6 | 1.0% | 90 |
| Example 24 | M6 | 2.0% | 75 |
| Example 25 | V6 | 2.0% | 78 |
| Example 26 | M10 | 0.5% | 93 |
| Example 27 | V10 | 0.5% | 96 |
| Example 28 | M10 | 1.0% | 88 |
| Example 29 | V10 | 1.0% | 92 |
| Example 30 | M10 | 2.0% | 81 |
| Example 31 | V10 | 2.0% | 87 |
| Example 32 | M12 | 0.5% | 92 |
| Example 33 | V12 | 0.5% | 95 |
| Example 34 | M12 | 1.0% | 87 |
| Example 35 | V12 | 1.0% | 92 |
| Example 36 | M12 | 2.0% | 82 |
| Example 37 | V12 | 2.0% | 87 |

In all of examples 2 to 37 the inventive specimens (M1-M12) exhibit better results in each case than the comparatives (V1-V12).

TABLE 4
Incorporation of micronized waxes into a blue hybrid
powdercoating material for the purpose of sliding friction
The waxes were mixed with the individual raw materials with one
another in a high-speed mixer and then the dry mixture was extruded
on a laboratory twin-screw extruder (PC19-25 from APV) at
110° C. and 250 rpm, ground to <125 μm and applied to aluminum
or steel panels by means of a spraygun with corona charging. After baking
(15 minutes at 180° C.) the coated panels were stored in a controlled-
climate chamber for 24 hours, after which the sliding friction
(according to Altek) was measured.

| | Wax | Wax fraction | Sliding friction |
|---|---|---|---|
| Example 38 | no wax | 0% | 0.33 |
| Example 39 | M3 | 0.5% | 0.27 |
| Example 40 | V3 | 0.5% | 0.29 |
| Example 41 | M3 | 1.0% | 0.25 |
| Example 42 | V3 | 1.0% | 0.27 |
| Example 43 | M3 | 2.0% | 0.21 |
| Example 44 | V3 | 2.0% | 0.25 |
| Example 45 | M4 | 0.5% | 0.22 |
| Example 46 | V4 | 0.5% | 0.24 |
| Example 47 | M4 | 1.0% | 0.20 |
| Example 48 | V4 | 1.0% | 0.23 |
| Example 49 | M4 | 2.0% | 0.15 |
| Example 50 | V4 | 2.0% | 0.18 |
| Example 51 | M11 | 0.5% | 0.17 |
| Example 52 | V11 | 0.5% | 0.19 |
| Example 53 | M11 | 1.0% | 0.16 |
| Example 54 | V11 | 1.0% | 0.17 |
| Example 55 | M11 | 2.0% | 0.13 |
| Example 56 | V11 | 2.0% | 0.15 |

In all of examples 38 to 56 the inventive specimens (M3, M4, M11) exhibit better results in each case (lower sliding friction) than the comparatives (V3, V4, V11).

TABLE 5
Incorporation into a white hybrid powdercoating material for
the purpose of improving the pencil hardness
The waxes were mixed with the individual raw materials with one
another in a high-speed mixer and then the dry mixture was extruded
on a laboratory twin-screw extruder (PC19-25 from APV) at 110° C.
and 250 rpm, ground to <125 μm and applied to aluminum or steel
panels by means of a spray gun with corona charging. After baking
(15 minutes at 180° C.) the coated panels were stored in a controlled-
climate chamber for 24 hours, after which the pencil hardness
(according to Wolff-Wilborn) was determined.

| | Wax, in each case 1% | Wolff-Wilborn pencil |
|---|---|---|
| | based on overall formula | hardness |
| Example 57 | no wax | 2B |
| Example 58 | M2 | HB |
| Example 59 | V2 | B |
| Example 60 | M3 | F |
| Example 61 | V3 | HB |
| Example 62 | M4 | F |
| Example 63 | V4 | HB |
| Example 64 | M6 | F |
| Example 65 | V6 | B |
| Example 66 | M7 | H |
| Example 67 | V7 | B |
| Example 68 | M10 | HB |
| Example 69 | V10 | HB |

In all of examples 57 to 69 it was possible to achieve a higher pencil hardness in each case with the inventive specimens than with the comparatives.

TABLE 6
Incorporation into a white hybrid powdercoating material for
the purpose of improving the abrasion resistance
The waxes were mixed with the individual raw materials with one
another in a high-speed mixer and then the dry mixture was extruded
on a laboratory twin-screw extruder (PC19-25 from APV) at 110° C.
and 250 rpm, ground to <125 μm and applied to aluminum or steel
panels by means of a spray gun with corona charging. After baking
(15 minutes at 180° C.) the coated panels were stored in a controlled-
climate chamber for 24 hours, after which the abrasion test on the
Taber Abraser was determined.

| | Wax, in each case 1% | Abrasion test after 200 |
|---|---|---|
| | based on overall formula | revolutions |
| Example 70 | no wax | 52 mg |
| Example 71 | M2 | 48 mg |
| Example 72 | V2 | 50 mg |
| Example 73 | M3 | 35 mg |
| Example 74 | V3 | 41 mg |
| Example 75 | M4 | 25 mg |
| Example 76 | V4 | 42 mg |
| Example 77 | M6 | 20 mg |
| Example 78 | V6 | 46 mg |
| Example 79 | M7 | 15 mg |
| Example 80 | V7 | 38 mg |
| Example 81 | M10 | 25 mg |
| Example 82 | V10 | 40 mg |

In all of examples 70 to 82 the inventive specimens exhibit better results (lower abrasion) in each case than the comparatives.

TABLE 7
Incorporation into a blue hybrid powdercoating material for
the purpose of improving the dispersion harshness of pigments
The waxes were mixed with the individual raw materials with one
another in a high-speed mixer and then the mixture was extruded
on a laboratory twin-screw extruder (PC19-25 from APV) at
110° C. and 250 rpm, in the course of which it was necessary to adjust
the metering amount for a power consumption of 70% on the extruder,
after which in this case the throughput was ascertained, and then the
mixture was ground to <125 μm and applied to aluminum or steel
panels by means of a spraygun with corona charging. After baking
(15 minutes at 180° C.) the coated panels were stored in a controlled-
climate chamber for 24 hours and thereafter the dispersion harshness
was determined via the depth of color.

| | Wax, in each case 1% | |
|---|---|---|
| | based on overall formula | Depth of color |
| Example 83 | no wax | 100% |
| Example 84 | M1 | 110% |
| Example 85 | V1 | 107% |
| Example 86 | M2 | 105% |
| Example 87 | V2 | 100% |
| Example 88 | M3 | 107% |
| Example 89 | V3 | 102% |
| Example 90 | M6 | 105% |
| Example 91 | V6 | 100% |
| Example 92 | M8 | 107% |
| Example 93 | V8 | 105% |
| Example 94 | M10 | 120% |
| Example 95 | V10 | 112% |

In all of examples 83 to 95 the inventive specimens exhibit better results (greater dispersion harshness) in each case than the comparatives.

TABLE 8
Incorporation into a blue hybrid powdercoating material for
the purpose of improving the throughput
The waxes were mixed with the individual raw materials with one
another in a high-speed mixer and then the mixture was extruded
on a laboratory twin-screw extruder (PC19-25 from APV) at 110° C.,
in the course of which it was necessary to adjust the metering amount
for a power consumption of 60% at 250 rpm on the extruder, after
which in this case the throughput was ascertained.

| | | | Throughput per |
|---|---|---|---|
| | Wax | Wax fraction | minute |
| Example 96 | no wax | 0% | 7500 g |
| Example 97 | M2 | 0.5% | 9000 g |
| Example 98 | V2 | 0.5% | 8600 g |
| Example 99 | M2 | 1.0% | 9200 g |
| Example 100 | V2 | 1.0% | 8700 g |
| Example 101 | M2 | 2.0% | 9500 g |
| Example 102 | V2 | 2.0% | 9000 g |
| Example 103 | M4 | 0.5% | 8500 g |
| Example 104 | V4 | 0.5% | 8200 g |
| Example 105 | M4 | 1.0% | 8700 g |
| Example 106 | V4 | 1.0% | 8400 g |
| Example 107 | M4 | 2.0% | 8800 g |
| Example 108 | V4 | 2.0% | 8400 g |
| Example 109 | M10 | 0.5% | 8000 g |
| Example 110 | V10 | 0.5% | 7500 g |
| Example 111 | M10 | 1.0% | 10 100 g |
| Example 112 | V10 | 1.0% | 9500 g |
| Example 113 | M10 | 2.0% | 11 000 g |
| Example 114 | V10 | 2.0% | 10 700 g |
| Example 115 | M12 | 0.5% | 7600 g |
| Example 116 | V12 | 0.5% | 7500 g |
| Example 117 | M12 | 1.0% | 8500 g |
| Example 118 | V12 | 1.0% | 8500 g |
| Example 119 | M12 | 2.0% | 9000 g |
| Example 120 | V12 | 2.0% | 8500 g |

In all of examples 96 to 120 the inventive specimens exhibit better results in each case (higher throughput) than the comparatives.

TABLE 9
Incorporation into a blue hybrid powdercoating material for
the purpose of improving the power consumption
The waxes were mixed with the individual raw materials with one
another in a high-speed mixer and then the mixture was extruded
on a laboratory twin-screw extruder (PC19-25 from APV) at
110° C., where the metering was adjusted to 3.0 and
subsequently the power consumption was measured.

| | | | Power |
|---|---|---|---|
| | Wax | Wax fraction | consumption |
| Example 121 | no wax | 0% | 69% |
| Example 122 | M2 | 0.5% | 61% |
| Example 123 | V2 | 0.5% | 62% |
| Example 124 | M2 | 1.0% | 60% |
| Example 125 | V2 | 1.0% | 62% |
| Example 126 | M2 | 2.0% | 57% |
| Example 127 | V2 | 2.0% | 61% |
| Example 128 | M4 | 0.5% | 65% |
| Example 129 | V4 | 0.5% | 67% |
| Example 130 | M4 | 1.0% | 62% |
| Example 131 | V4 | 1.0% | 64% |
| Example 132 | M4 | 2.0% | 59% |
| Example 133 | V4 | 2.0% | 62% |
| Example 134 | M10 | 0.5% | 59% |
| Example 135 | V10 | 0.5% | 63% |
| Example 136 | M10 | 1.0% | 54% |
| Example 137 | V10 | 1.0% | 60% |
| Example 138 | M10 | 2.0% | 51% |
| Example 139 | V10 | 2.0% | 54% |
| Example 140 | M11 | 0.5% | 60% |
| Example 141 | V11 | 0.5% | 63% |
| Example 142 | M11 | 1.0% | 56% |
| Example 143 | V11 | 1.0% | 61% |
| Example 144 | M11 | 2.0% | 54% |
| Example 145 | V11 | 2.0% | 57% |
| Example 146 | M12 | 0.5% | 60% |
| Example 147 | V12 | 0.5% | 66% |
| Example 148 | M12 | 1.0% | 59% |
| Example 149 | V12 | 1.0% | 63% |
| Example 150 | M12 | 2.0% | 58% |
| Example 151 | V12 | 2.0% | 60% |

1. A powdercoating material comprising an additive, wherein the additive includes at least one polyolefin wax synthesized using a metallocene catalyst, where the polyolefin wax has a dropping point of from 70 to 165° C., a melt viscosity at 140° C. of from 10 to 10 000 mPa s, a density of from 0.85 to 0.98 g/cm³ and a molecular weight distribution, expressed as M_{w}/Mₙ, of less than 5 and wherein the polyolefin wax is present in a blend with one or more auxiliaries and additives selected from the group consisting of
a) polyethylene glycol
b) PE waxes,
c) PTFE waxes,
d) PP waxes,
e) amide waxes,
f) FT paraffins,
g) montan waxes,
h) natural waxes,
i) macrocrystalline and microcrystalline paraffins,
j) polar polyolefin waxes,
k) sorbitan esters
l) polyamides,
m) polyolefins,
n) PTFE,
o) wetting agents or
p) silicates.

2. The powdercoating material as claimed in claim 1, wherein the polyolefin wax is derived from olefins having 3 to 6 carbon atoms or from styrene.

3. The powdercoating material as claimed in claim 1, wherein the polyolefin wax is polar modified.

4. The powdercoating material as claimed in claim 1, wherein polyolefin wax and the one or more auxiliaries and additives are in the form of an ultrafine powder having a particle size distribution d₉₀<40 μm.

5. A process for preparing a powdercoating material comprising the step of adding an additive to the powdercoating material, wherein the additive includes at least one polyolefin wax synthesized using a metallocene catalyst, where the polyolefin wax has a dropping point of from 70 to 165° C., a melt viscosity at 140° C. of from 10 to 10 000 mPa s, a density of from 0.85 to 0.98 g/cm³ and a molecular weight distribution, expressed as M_{w}/Mₙ, of less than 5 and wherein the polyolefin wax is present in a blend with one or more auxiliaries and additives selected from the group consisting of
a) polyethylene glycol
b) PE waxes,
c) PTFE waxes,
d) PP waxes,
e) amide waxes,
f) FT paraffins,
g) montan waxes,
h) natural waxes,
i) macrocrystalline and microcrystalline paraffins,
j) polar polyolefin waxes,
k) sorbitan esters
l) polyamides,
m) polyolefins,
n) PTFE.
o) wetting agents or
p) silicates.

6. The powdercoating material as claimed in claim 1, wherein the polyolefin wax: auxiliary and additive weight ratio is 1:50 to 50:1 expressed in % by weight.

7. The process as claimed in claim 5, wherein the polyolefin wax: auxiliary and additive weight ratio is 1:50 to 50:1 expressed in % by weight.

8. An article coated with the powdercoating material as claimed in claim 1.
